(19) United States
(12) Patent Application Publication
(10) Pub. No.: US 2026/0062653 A1
(43) Pub. Date: Mar. 5, 2026

(54) PROCESS OF ALCOHOLIC FERMENTATION OF STARCHY SUBSTRATES WITH ELIMINATION OF THE YEAST PROPAGATION STEP, AND WITHOUT THE USE OF SEPARATOR CENTRIFUGES

(71) Applicants: Alexandre GODOY, Piracicaba (BR); Guilherme Marengo FERREIRA, Piracicaba (BR)

(72) Inventors: Alexandre GODOY, Piracicaba (BR); Guilherme Marengo FERREIRA, Piracicaba (BR)

(21) Appl. No.: 19/113,043

(22) PCT Filed: Apr. 22, 2024
(86) PCT No.: PCT/BR2024/050165

§ 371 Date: Mar. 19, 2025

(30) Foreign Application Priority Data
May 30, 2023 (BR) 1020230105726

(51) Int. Cl. C12G 3/021

(52) U.S. Cl. CPC C12G 3/021

(57) ABSTRACT

An alcoholic fermentation process that eliminates the yeast propagation step and dispenses with the use of separator centrifuges. An objective is to remove the yeast propagation step in ethanol production processes based on starchy substrates, resulting in reduced fermentation time, improved fermentation yield, and significant reductions in operating costs, particularly regarding the daily acquisition of yeasts.

### FIELD

The invention that motivates this patent application, particularly in the process category, has its application particularly focused on the cereal-based ethanol production segment.

### BACKGROUND

The conventional ethanol process of cereals (e.g., corn, barley, sorghum, wheat, cassava) has been traditionally carried out for decades, using daily yeast propagations, which, at the end of this phase (approximately 10 hours), are inoculated together with the must (starchy substrate) in the fermenters, and remain in the fermentation process for 60 to 70 hours, or more.

This long fermentation time is due to the low inoculum of yeasts in the medium, even with the propagation of yeasts in the propagators.

Accordingly, at the end of the fermentation process, due to the long fermentation period, during which the yeast remains in contact with the high alcohol content and acidity of the wine, they practically reach the end of fermentation dead, or with very low viability/fermentative activity. For this reason, the whole fermented substrate (wine), without separation of solids and yeasts, is sent directly to the distillation step to obtain ethanol.

More recently (2018), a new technology was developed (StarchCane® Fermentec, with a patent applied for with the INPI and already patented in the USA), which allows the yeasts, at the end of fermentation, to be recovered through 2 (two) centrifugation steps, thus eliminating the yeast propagation step. In the first step of centrifugation, the “heavy” fraction of the wine (which are the fibers/wet cake) is separated through centrifuges Decanters, which will form the DDGS bran. In the other way of centrifugation, there is wine with the yeasts. This wine, similar to the fermentation process for the production of sugarcane (Melle Boinott), is sent to a second centrifugation system, through Sedicanters centrifuges, where the yeast cream is separated, and on the other path, the deyeasted wine is sent for distillation.

In this preparation, which uses the StarchCane process, the yeast cream proceeds to the pre-fermentation step, where, after being diluted with water, it undergoes acid treatment and remains for 1 to 2 hours, exactly as it occurs in the fermentation of sugarcane and/or molasses. Once the pre-fermentation step (acid treatment of the yeast) is completed, this inoculum is sent to the fermenters, to start a new fermentation cycle. This process has a number of advantages compared to the conventional process (with daily propagation of yeasts and without recycling), namely:
Fast fermentations (around 20 to 25 hours), compared to the conventional process (60 hours), due to the high population of yeasts in the medium;
Higher fermentation yields, since, without the need for yeast propagation, less sugar is diverted to the production of cellular biomass, increasing the conversion into ethanol;
Elimination of the yeast propagation step, due to the use of centrifuges to recover the yeasts at the end of each fermentation cycle.
Fermentation is conducted at low temperature (28° C.), with the use of chillers, due to the high alcohol content of the wine, and to protect the yeasts from this stress condition. This also brings an advantage in controlling bacterial contamination and acidity of the wine, also reducing the use of antimicrobials in fermentation.

### SUMMARY

This patent application concerns the invention of an alcoholic fermentation process for starchy substrates that eliminates the yeast propagation step and dispenses with the use of separator centrifuges. The objective is to remove the yeast propagation step in ethanol production processes based on starchy substrates, resulting in reduced fermentation time, improved fermentation yield, and lower operating costs, particularly regarding the daily acquisition of yeasts.

The objective of the process proposed in this patent application is precisely to serve as an intermediate process between the conventional system (with daily yeast propagation and without recycling)—which is the most widely used worldwide-, and the StarchCane technology (with yeast recycling through the use of centrifuges, providing higher fermentation yields).

With the technology proposed here, by eliminating the propagation step but without the use of centrifuges, it will certainly not be possible to achieve all the advantages obtained with the StarchCane® technology. However, it will allow for much better and more advantageous results compared to the conventional technology traditionally used worldwide for the production of ethanol from cereals. However, in a cost-benefit ratio, considering the production parameters and necessary equipment, the present invention becomes very competitive, meeting the market needs at a compatible cost.

The conventional process, practically used all over the world for the production of ethanol from cereals, has high fermentation times (60 hours), in addition to the need to carry out the step of yeast propagation at each new fermentation cycle, throughout the year. Consequently, it presents a loss of productivity in ethanol, and in the installed fermentation capacity, not to mention higher operating costs with the purchase of yeasts all year round.

On the other hand, the StarchCane® technology presents a significant advancement compared to conventional fermentation; however, it requires a greater number of equipment to recycle the yeasts and demands more careful management of the process. However, it promotes significantly higher fermentation yields, greater fermenter productivity, and lower operating costs, justifying the investments.

The process proposed in this invention is much simpler to be conducted compared to the StarchCane® technology, and allows a quick and simple adaptation to the conventional system, as well as a series of gains described in the next paragraphs.

Within the objective of the present invention, namely, to eliminate the yeast propagation step in ethanol production processes based on starchy substrates, reduce fermentation time, achieve gains in fermentation yield, and reduce operating costs (mainly with the daily purchase of yeasts), can be associated with significant advantages over conventional processes:
Elimination of the yeast propagation step, with a reduction of Opex;
Reduction in fermentation time by at least 10 hours, which is already a huge advantage when considering fermentations of 60 to 70 hours;
Increased ethanol productivity, that is, with the same installed fleet of vats to produce more ethanol;
Gains in fermentation yield (between 1.0 and 1.5% minimum) as a result of eliminating the propagation of yeasts, diverting more sugar to be converted into ethanol in fermentation.

Regarding the technology with recycling through centrifuges (StarchCane®), the present invention stands out for being simpler to conduct compared to the aforementioned StarchCane® technology, allowing for a quick and simple adaptation to the conventional system, with the use of simplified equipment.

In conventional ethanol production processes from starchy substrates, due to the presence of solids (mainly fibers) in the substrate to be fermented, unlike the fermentation of sugarcane juice/molasses (Melle-BoinottProcess), it is not possible to carry out the yeast centrifugation step to separate the “yeast cream” and start a new fermentation cycle.

In this way, it is necessary to carry out a step prior to fermentation, which is the daily yeast propagation step, or at each new fermentation cycle, in tanks specifically designed for this, called yeast propagators. This step takes around 10 hours, and after this period, they are sent to the fermenters.

In these propagators, in addition to the yeasts (dehydrated or wet), a portion of wort (substrate to be fermented) is added, along with enzymes to break down starch into glucose, so they can be metabolized by the yeasts, allowing for their multiplication/propagation, as well as adding nutrients (urea) and antimicrobials to control infection.

In this way, part of the sugars that would be converted into ethanol are directed to the production of cellular biomass. It is known and proven that for every 1% of the sugar diverted by yeasts to the production of cellular biomass, 1% less ethanol is produced, which is already a disadvantage of this procedure, but it is necessary to meet the fermentation step in this process.

Normally, the capacity of these propagators represents 2 to 5% in relation to the capacity of each fermenter (vat).

It is a very small volume, and even after the propagation period, the yeast population (cells/mL) sent to the fermenters is very low, less than 0.5% in relation to the total volume.

This leads to an excessively high fermentation time (60 hours on average). Consequently, the yeasts, after being in contact with the high alcohol content and acidity of the wine for all this time, die at the end of each fermentation cycle. In this way, the wine is sent in its entirety to the distillation process (without the separation of the yeasts and solids), and ethanol is obtained after this process. Additionally, it results in vinasse with solids that will be separated and sent to the drying system for the production of DDG/DDGS bran, or they can even be sold directly in wet form (WDG), although this is uncommon in Brazil.

With the experience that Brazil has in alcoholic fermentation processes acquired thanks to the existence of the National Alcohol Program since the 1970s, it has been possible to gain enormous knowledge about fermentations, especially with the yeast recycling system. This also allowed for the selection of yeast strains with high performance in recycling processes, tolerant to high alcohol levels in fermentation, with high robustness, and with a high rate of permanence in the process, practically remaining throughout the entire harvest period and predominating in fermentation. Some of these yeasts have also demonstrated excellent performance in starch fermentations.

In this way, with all the knowledge acquired regarding the characteristics of these yeasts, it became possible to reuse these yeasts in each fermentation cycle, but without the use of centrifuges and without the need for daily propagation, which is the objective/inventive character of this document, offering a series of advantages over the conventional system for starch fermentation used worldwide.

The principle of this technology to obtain this yeast inoculum to be used in a new fermentation cycle is based on separating part of the substrate at the beginning of fermentation (which will vary from case to case) and sending it to the next fermenter to be fermented in the sequence of the process, and so on. Logically, a series of requirements/parameters will have to be taken into account for the success of these operations, such as:
Type/strain of yeast used;
Determination of the best time to perform this procedure (fermentation time);
Condition of the yeast at each step of the process;
Volume of inoculum to be removed from one fermenter to another;
Fermentation temperature;
Alcohol content of the wine;
Dosage of enzymes, mainly gluco-amylase;
Feeding time of fermenters with wort;
Sprouting of yeasts (“budding”);
Other factors, case by case.

### BRIEF DESCRIPTION OF THE DRAWING

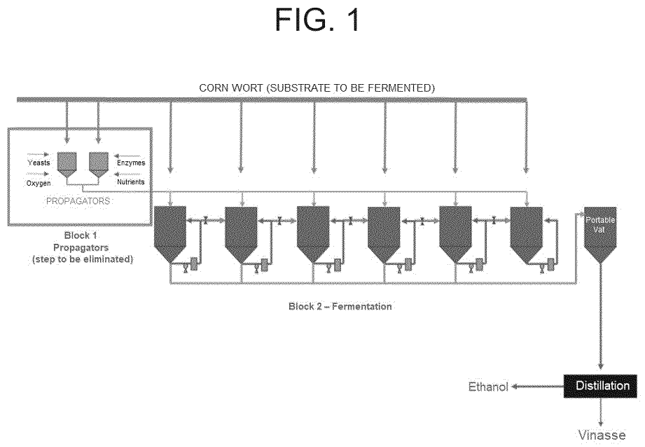

The invention will be described in greater detail below, and, for a better understanding, references will be made to the attached drawing (FIG. 1), in which it is represented: the character of the invention is within the red rectangle (Block 1) highlighted in the general flowchart of the process, which represents the step of propagation of the yeasts, a step that will be eliminated, and it is precisely the inventive character of this document in question. In Block 2, which is the fermentation step itself, it can be observed, in the red arrows (S1), how part of the yeasts will be sent to the other fermenter, to start a new fermentation cycle. At the end of this fermentation process, the entire fermented substrate is sent to the distillation step.

### DETAILED DESCRIPTION OF THE EMBODIMENTS

The PROCESS OF ALCOHOLIC FERMENTATION OF STARCHY SUBSTRATES WITH ELIMINATION OF THE YEAST PROPAGATION STEP, AND WITHOUT THE USE OF SEPARATOR CENTRIFUGES, object of this application for patent of invention, shows, according to FIG. 1, a Block (1) highlighted in the general flowchart of the process, which represents the yeast propagation step, which will be eliminated, in which the propagators (2) are observed, with the injection of yeasts, oxygen, enzymes, nutrients, and the must (3) (product to be fermented).

Block (4)—the fermentation step itself—occurs at a temperature of 33° C. and a pressure of 1000 mmca, and reveals the various vats (5) that receive the propagators (2), so that, through the red arrows (S1), part of the yeasts are sent to another fermenter (vat) to start a new fermentation cycle, with the vats (5) communicating with the mobile vat (5′); at the end of this mobile vat (5′), all the fermented substrate is sent to the distillation step (6), to be directed to ethanol production or used as vinasse.

As practical results obtained with the use of the object of the patent, the following can be listed:
Elimination of the yeast propagation step, with a significant reduction in Opex: As a practical example, in financial terms, considering a distillery that produces 750 m³ of corn ethanol per day, we have the following scenario:
Yeast consumption: 10 Kg/Propagator;
They prepare an average of 3.5 propagators/day;
Daily yeast consumption: 35 Kg;
Yeast Cost: R$218.00/Kg;
Corn Process Days: 345 days/year:
   In this way, we have: 35 Kg/day×345 days×R$218.00/Kg=R$2.63 Million/year;
Reduction in fermentation time by at least 10 hours, which is already a huge advantage when considering fermentations of 60 to 70 hours;
Gains in fermentation yield (between 1.0 and 1.5% minimum) as a result of eliminating the propagation of yeasts, diverting more sugar to be converted into ethanol during fermentation;
   Conservatively, let us consider gains of 1.0% in fermentation yield:

$$750 MLPD \times 1. \% = + 7.5 {m}^{3} ethanol / day \times 345 days = \sim + 2 , 600 {m}^{3} of ethanol / year \times R \$3 , 150. {m}^{3} of ethanol = R \$8 \text{.2} million / year .$$

Adding the 2 benefits (savings with the elimination of the propagation process and gain in fermentation yield), the economic gains exceed R$11.0 million reais per year, resulting in a significant increase in the company's profits with the adoption of this procedure presented herein.

By way of clarification, according to the National Confederation of Industry (CNI), corn ethanol production has skyrocketed almost 800% in the last five years, from 520 million liters in the 2017/18 harvest to 4.5 billion in the 2022/23 harvest. And it is forecast to reach 10 billion liters by 2030.

Thus, if all corn distilleries in Brazil start to adopt the procedure that is being presented in this patent application, considering the production of 2030 (10 billion liters of corn ethanol), and considering fermentation yield gains of at least 1.0%, this will represent an additional production of 100 million liters of ethanol for producers. Considering that the value of m³ of ethanol is R$3, 150, this represents R$315 million reais/year.

As for the value of yeasts, which are dosed at an average proportion of 0.047 g/Liter of ethanol, and the cost of yeasts is around R$0.01/Liter of ethanol produced, we find that, for an annual production of 10 billion liters (2030), the savings generated by this procedure could reach R$100 million reais.

Thus, adding the gains from the purchase of yeasts and the fermentation yield, adopting the procedure mentioned herein will represent R$415 million/year for corn ethanol producers in Brazil, which, if replicated in other cereal-producing countries, will extraordinarily increase productivity and competitiveness figures.

1-3. (canceled)

4. A process of alcoholic fermentation of starchy substrates with elimination of the yeast propagation step, and without the use of separator centrifuges, according to which the yeast propagation step and the use of separator centrifuges are eliminated, comprising: a step of yeast propagation, which will be eliminated, in which the propagators are observed, with the injection of yeasts, oxygen, enzymes, nutrients, and the must (product to be fermented); wherein the block—the fermentation step itself—reveals the various vats that receive the propagators, so that, through the red arrows, part of the yeasts are sent to another fermenter to start a new fermentation cycle.

5. The process of alcoholic fermentation of starchy substrates with elimination of the yeast propagation step, and without the use of separator centrifuges according to claim 4, wherein the vats are in communication with a mobile vat; and at an end of the mobile vat, all of the fermented substrate is sent to the distillation step, to be directed to ethanol production or used as vinasse.

6. The process of alcoholic fermentation of starchy substrates with elimination of the yeast propagation step, and without the use of separator centrifuges according to claim 5, wherein the fermentation step occurs at a temperature of 33° C. and a pressure of 1000 mmca.
